(19) United States
(12) Patent Application Publication
(10) Pub. No.: US 2002/0026482 A1
(43) Pub. Date: Feb. 28, 2002

(54) Gateway apparatus and method of providing information to mobile terminals

(76) Inventors: Takehiro Morishige, Hachioji (JP); Hidenori Inouchi, Higashimurayama (JP); Takumi Ohishi, Yokohama (JP); Haruo Shibata, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/811,388

(22) Filed: Mar. 20, 2001

(30) Foreign Application Priority Data
Aug. 24, 2000 (JP) 2000-259373

(51) Int. Cl. G06F 15/173; G06F 15/16

(52) U.S. Cl. 709/206; 709/242; 709/249; 340/7.29

(57) ABSTRACT

A push-type information providing service, wherein a request for setting management information as to information service to a mobile terminal 2 is issued from a service management node 4 for managing a visit location of the mobile terminal to a gateway when the location of the mobile terminal is registered in a mobile packet communication network 12. The gateway 3 requests a push server 1 to start the information service as necessary, and selectively transfers a service information packet received from the push server to the mobile terminal 2.

### BACKGROUND OF THE INVENTION

(1) Field of the Invention

The present invention relates to a gateway apparatus and a method of providing information to mobile terminals. More particularly, the invention relates to a gateway apparatus and a push-type information providing method for providing service information transmitted from a server to a plurality of mobile terminals matching an information delivering condition.

(2) Description of the Related Art

In recent years, the Internet and mobile communication services are being rapidly spread. Communication in the Internet is carried out according to an IP packet conformed with the IP (Internet Protocol, RFC791) as a de facto standard, and an IP address for identifying an apparatus is globally-unconditionally allocated to each of apparatuses connected to the Internet. On the other hand, in mobile communication service, the ratio of data communication to voice communication is being increased. In order to provide efficient data communication service, a mobile packet communication network is being actively examined. PDC-P (PDC-packet) and GPRS (General Packet Radio Service) are known as examples of the mobile packet communication network. In a third-generation mobile communication system IMT-2000 as well, high-speed packet communication service is scheduled to be provided.

At present, the IP (Internet Protocol, RFC791) is commonly used as a high-order communication protocol in a mobile packet communication network. In order to provide communication service in the IP protocol in a mobile packet communication network, an exchange carrier has to assign a peculiar IP address to each mobile terminal. In association with an explosion of mobile terminals, however, the number of IPv4 addresses is becoming short, and it is becoming difficult to assign a globally peculiar IP address (global address) to each terminal.

Consequently, for example, such a method is being examined that assigns a private IP address peculiar in each mobile packet communication network to a mobile terminal, disposes a gateway (NAT-GW) having the function of network address translation (NAT) between the mobile packet communication network and the Internet, and uses a global IP address held by the gateway for communication between the mobile packet communication network and the Internet. Adoption of an IPv6 address having a length of 128 bits in place of a current IP address (IPv4) having a length of 32 bits is also being examined.

As new information service in a mobile packet communication network, for example, push-type information delivery service typified by radio advertisement is expected. In the push-type information delivery service, service information is distributed whenever necessary from a push server connected to the mobile packet communication network to an indefinite number of mobile terminals or service-contracted mobile terminals.

As an example of a conventional technique for providing information service of a broadcast type from a server (transmission host) to a fixed terminal (receiving host) connected to the Internet, Japanese Unexamined Patent Application No. 10-242962 discloses a communication method of disposing a multicast gateway between the receiving host and transmission host, receiving a broadcast message sent as an IP multicast datagram from the transmission host by the multicast gateway, converting a duplicate of the received message to an IP unicast datagram, and transferring the IP unicast datagram to each of the receiving hosts.

The conventional technique is proposed on the presumption of using a receiving host having no IP multicast communication function. Each receiving host sends a message reception start command in which a group ID is designated to the multicast gateway prior to reception of a broadcast message. The multicast gateway stores the corresponding relation between the group ID designated by the command and the IP address of the receiving host. When a message is received from the transmission host, the multicast gateway extracts the group ID from a destination IP multicast address included in the received message, and unicasts a duplicate of the received message to the receiving host IP address corresponding to the group ID.

In a network configuration in which amiable packet communication network is connected to the Internet via the NAT-GW, the corresponding relation between a private IP address assigned to each mobile terminal and a representative address (global address) of the NAT-GW is managed on a session unit basis. Since the NAT-GW holds the corresponding relation between the private IP address and the global address only on a session in connection, for example, as typified by an access of a WWW (World Wide Web) server, it is suitable for the case of accessing a server from a mobile terminal and providing information service from the server to the mobile terminal in a state where a connection is being established between the terminal and the server.

In a push-type information delivery service promising in a mobile packet communication network, however, when a mobile terminal requests a push server to provide service, the push server provides information service in a state where the session is disconnected once. In this case, in the conventional NAT-GW, when service information is received from the push server, the corresponding relation between the private IP address of the mobile terminal and the global address is in a lost state. Consequently, the information cannot be forwarded from the NAT-GW to the mobile terminal.

In the case of applying the above-described communication method disclosed in Japanese Unexamined Patent Application No. 10-242962 to a mobile packet communication network, each of mobile terminals has to have a special function for transmitting a message reception start command to a multicast gateway prior to the information service. In the conventional technique, all of messages are transmitted in a multicast packet format from the server (transmission host) to the multicast gateway. When the multicast packet is sent via the Internet, there is no guarantee that the multicast packet is received by the multicast gateway with reliability.

General push type information delivery service according to the IP protocol employs a transfer control system adapted to an IP address for specifying the IP address of each terminal, to which information is to be delivered, from the destination IP address of an IP packet sent from a push server. In the transfer control system, for example, it becomes difficult to realize information delivery service for selectively providing service information only to mobile terminals existing in a specific area or terminals satisfying a specific condition.

### SUMMARY OF THE INVENTION

An object of the invention is to provide a gateway apparatus and an information providing method capable of providing push-type information delivery service to a mobile terminal without adding a specific function to the mobile terminal.

Another object of the invention is to provide a gateway apparatus and an information providing method capable of selectively delivering push-type information supplied from a server to a specific mobile terminal group matching a delivery condition.

Further another object of the invention is to provide a gateway apparatus and an information providing method capable of selectively delivering area-limited information supplied from a server to a specific mobile terminal group positioned in a designated area.

In order to achieve the objects, according to the invention, there is provided an information providing method on a communication network comprising a mobile packet communication network accommodating a plurality of mobile terminals via a radio channel and an IP (Internet Protocol) core network to which a server for providing information service is connected, the mobile packet communication network and the IP core network being connected via a gateway apparatus, wherein when the location of a mobile terminal is registered in the mobile packet communication network, a request of setting management information for information service to the mobile terminal is made designating a mobile terminal address and an information service identifier from a service management node for managing visit location information of each mobile terminal in the mobile packet communication network to the gateway apparatus, the gateway apparatus having received the setting request registers management information regarding the mobile terminal into a management table, checks whether a service request has been issued to a service provider with respect to information service to be provided to the mobile terminal, and requests a specific server as the service provider to start the information service if a service request has not been issued yet.

According to the information providing method of the invention, at the time of registering the management information of amiable terminal into a management table, the gateway apparatus registers, for example, location information obtained from a location information server for managing geographical position information of each of mobile terminals in the mobile packet communication network as a part of the management information into the management table. Consequently, when a packet designating a delivery area is received as information service, the gateway apparatus refers to the management table, selects a group of specific mobile terminals presently locating in the designated area, thereby to delivery the received packet to the group of selected mobile terminals.

More specifically, according to the invention, the gateway apparatus has: for example, a first management table for storing, in correspondence with each service identifier, an address of a server operating as a provider of service, a destination address to be attached to a service information packet, and status information indicative of whether a service request has been issued or not; and a second management table for storing management information regarding the mobile terminal, and when a packet including the service information is received from a server, the gateway apparatus specifies a service identifier corresponding to the received packet with reference to the first management table, and searches the second management table for a management information record including the service identifier, thereby specifying an address of a mobile terminal to which the received packet is to be transferred.

In the configuration, for example, by preliminarily designating a filtering condition in correspondence with a specific service identifier in the first management table, when a service information packet is received from a server, in the case where a filtering condition is designated in correspondence with a service identifier specified in the first management table, the gateway apparatus makes an address of a mobile terminal of which management information satisfies the filtering condition valid among addresses of mobile terminals specified in the second management table, and the valid address can be used as a destination of the received packet.

According to another aspect of the invention, there is provided a gateway apparatus for connecting a mobile packet communication network accommodating a plurality of mobile terminals via a radio channel, and an IP (Internet Protocol) core network to which a server for providing information service is connected, comprising: means for registering management information regarding the mobile terminal into a management table when a setting request of the management information for information service to the mobile terminal is received from a service management node for managing a visit location of the mobile terminal in the mobile packet communication network, and if a service request of information service to be provided to the mobile terminal has not been made to a service provider, requesting a specific server as the service provider to start the information service; and packet transferring means for specifying when a packet including service information is received from the specific server an address of a mobile terminal, to which information service by the received packet is to be provided, from the management table, and transferring the received packet to the mobile packet communication network by using the address as a destination address.

According to the invention, by the packet transferring means, a service information packet can be received in a multicast packet format from a server, and a service information packet can be transferred in a unicast packet format to a mobile terminal specified in the management table. By the packet transferring means, a destination address of a packet received from a specific server can be converted from a global IP address to a private IP address, and the packet can be transferred to a mobile terminal by using the private IP address. For example, in the case of delivering information from a server having an IPv4 address to a mobile terminal having an IPv4/IPv6 address, the address of the received packet can be converted from the IPv4 global address to the IPv4 private/IPv6 address by the gateway apparatus.

The other objects, features, and effects of the invention will become apparent from the description of the embodiments of the invention with reference to the drawings.

### BRIEF DESCRIPTION OF THE DRAWINGS

FIG. 1 is a diagram showing an example of a communication network for providing information delivery service according to the invention.

FIG. 2 is a block diagram showing the configuration of a gateway.

FIG. 3 is a diagram showing the configuration of a destination mobile terminal information management table held by the gateway.

FIG. 4 is a diagram showing the configuration of a service information management table held by the gateway.

FIG. 5 is a sequence chart of a preparing process for starting push-type information delivery service according to the invention.

FIG. 6 is a sequence chart of a contents delivery process in the push-type information delivery service according to the invention.

FIG. 7 is a diagram showing an example of the format of an IP packet transferred between a mobile terminal and a push server.

FIG. 8 is a flowchart of a packet receiving process program 500 executed by the gateway.

FIG. 9 is a flowchart showing the details of a filter scenario process R550 in the packet receiving process program 500.

FIG. 10 is a sequence chart showing a procedure of ending contents delivery service in response to a disconnection request as a trigger from a mobile terminal 2.

FIG. 11 is a sequence chart showing a procedure of ending the contents delivery service in response to a disconnection request as a trigger from a foreign agent node (subscriber node) 6.

FIG. 12 is a sequence chart showing a procedure of ending the contents delivery service in response to a disconnection request as a trigger from a contractor management node 4.

### DESCRIPTION OF THE PREFERRED EMBODIMENTS

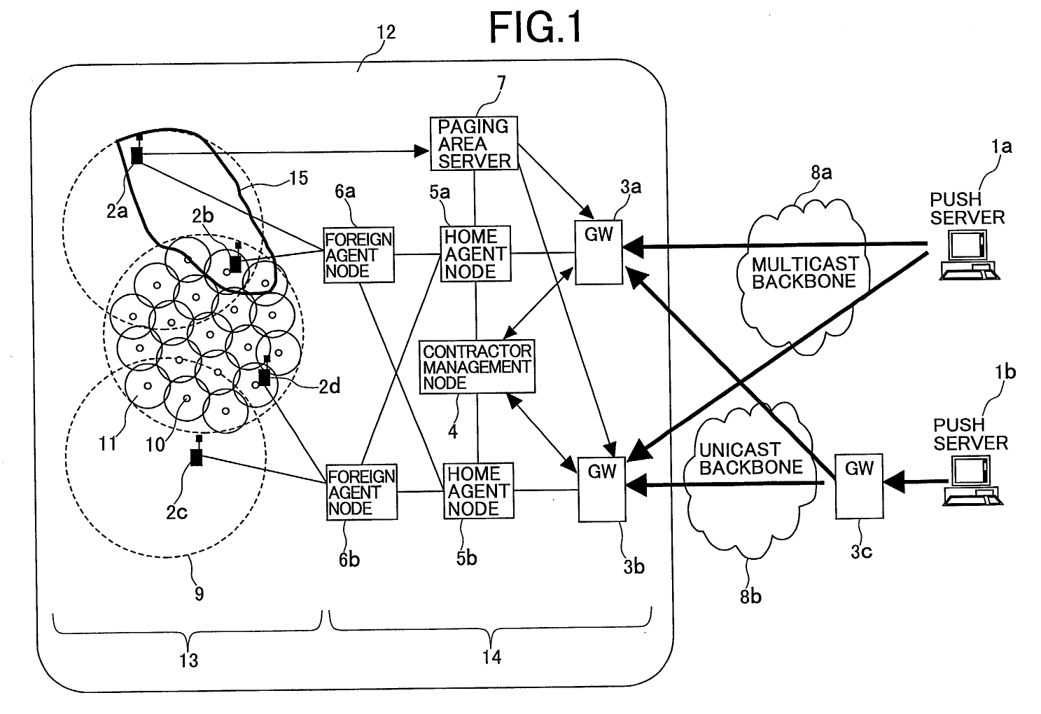

FIG. 1 shows an example of the configuration of a communication network capable of providing area-limited push-type information delivery service according to the invention to users of a mobile packet communication network.

The communication network shown here is constructed by a mobile packet communication network 12 and an IP core network 8. The IP core network 8 includes a multicast backbone 8a capable of transferring a multicast packet and an ordinary unicast backbone 8b. To the IP core network 8 (8a and 8b), push servers 1 (1a and 1b) for providing various contents information to mobile terminals connected to the mobile packet communication network 12 and fixed terminals (not shown) connected to the Internet 8b are connected.

The mobile packet communication network 12 is constructed by a radio access network 13 and a radio core network 14 for connecting the radio access network 13 to the IP core network 8. The radio access network 13 includes a plurality of radio base stations 10. Each radio base station 10 communicates with mobile terminals 2 (2a, 2b, . . . ) positioning in a cell 11 via a radio channel. The radio core network 14 comprises: a plurality of gateways 3 (3a, 3b, . . . ) for connecting the mobile packet communication network 12 to the IP core network 8; a plurality of home agent nodes 5 (5a, 5b, . . . ) in association with the gateways 3; a plurality of foreign agent nodes 6 (6a, 6b, . . . ) each having a predetermined zone 9 including a group of radio base stations as a control zone; and a contractor management node 4 and a paging area server 7 accessed by each of the gateways 3.

The gateway 3 and the home agent node 5 associated with the gateway 3 may be constructed as a single node in a practical application. In the contractor management node 4 connected to the gateways (3a, 3b . . . ) via the home agent nodes (5a, 5b, . . . ), contractor information, mobile terminal visit location information, and information of identifying service which can be provided to the contractor is stored. The paging area server 7 is used to provide geographical positional information indicative of a current position of each mobile terminal, and communicates with the plurality of gateways 3 via any of the home agent nodes (home agent node 5a in this example). In the embodiment, the paging area server 7 is disposed in the radio core network 14 in order to realize the area-limited push-type information service. However, other server may be installed in order to provide information other than the position information regarding a mobile terminal.

Each of the gateways 3 has: the function of carrying out communication according to the Internet protocol with the IP core network 8 other than the mobile packet communication network 12 such as the Internet; the function of holding service contract information for each mobile terminal and requesting the push server 1 to start delivery service in place of mobile terminals as will be described hereinlater; and the function of receiving a service information packet (contents) from the push server 1 and transferring the duplicate of the received contents to specific mobile terminals 2 contracting service. When the received contents are accompanied by a special delivery condition, the duplicate of the received contents is transferred to the specific mobile terminals matching the delivery condition by the transfer function.

The gateway 3c connected to the push server 1b in the IP core network has the function of converting a multicast address added to the contents received from the push server 1b to a unicast address and transmitting the duplicate of the received contents to each of the gateways (3a, 3b, . . . ) in the mobile packet communication network by using the unicast address, or the function of converting the multicast packet into a unicast packet and transmitting the unicast packet to each of unicast addresses.

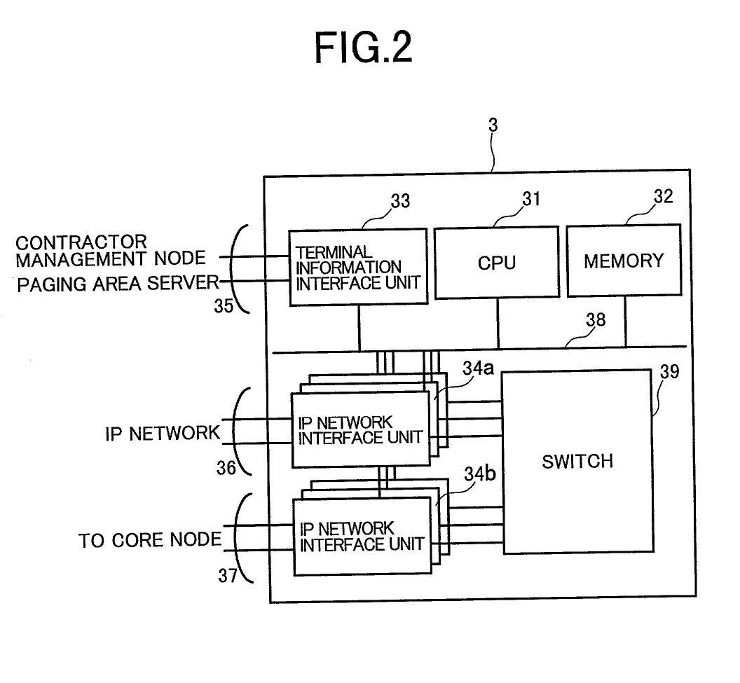

FIG. 2 shows the configuration of the gateway 3 (3a, 3b). The gateway 3 is comprised of: a CPU 31 for controlling the transmission and reception of signals to and from the home agent node 5 and other network; a memory 32; a terminal information interface unit 33 for terminating signal lines 35 connected to the contractor management node 4 and the paging area server 7; IP network interface units 34 (34a, 34b, . . . ) for terminating signal lines 36 connected to other IP network and signal lines 37 connected to other node in the core network 14; a bus 38 for connecting the above elements; and a switch 39 connected to the IP network interface units 34 (34a, 34b, . . . ). The CPU 31 communicates with, for example, the home agent node 5 and apparatuses connected to the other network in accordance with the Internet protocol.

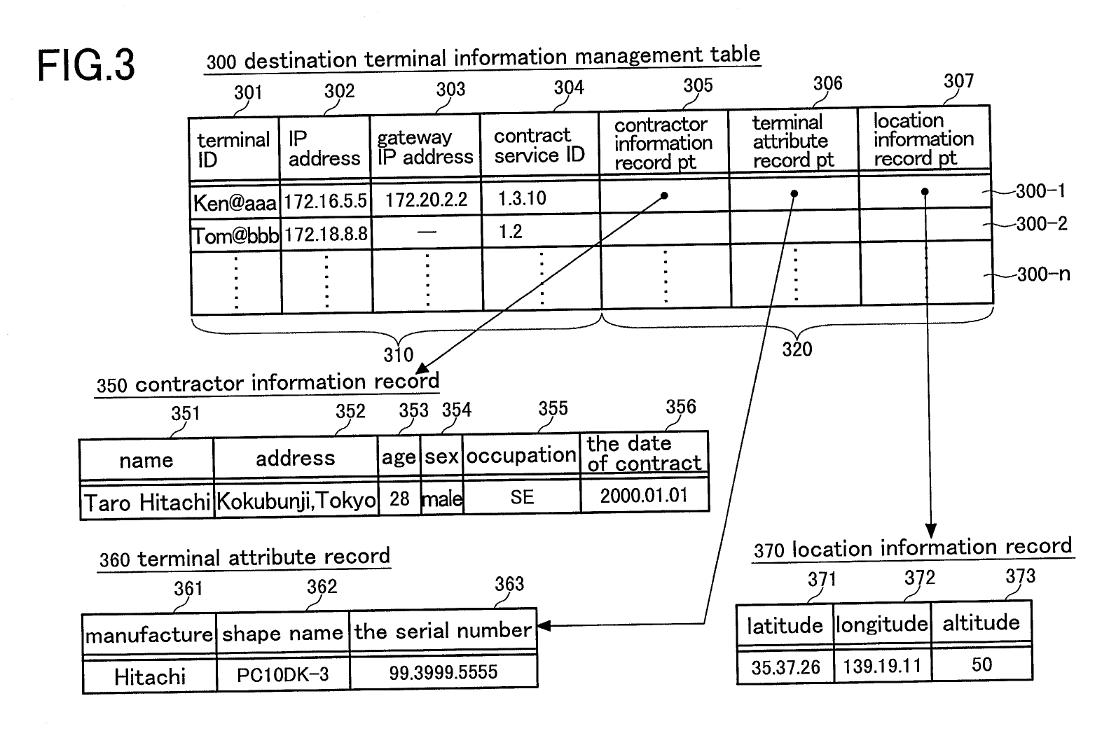

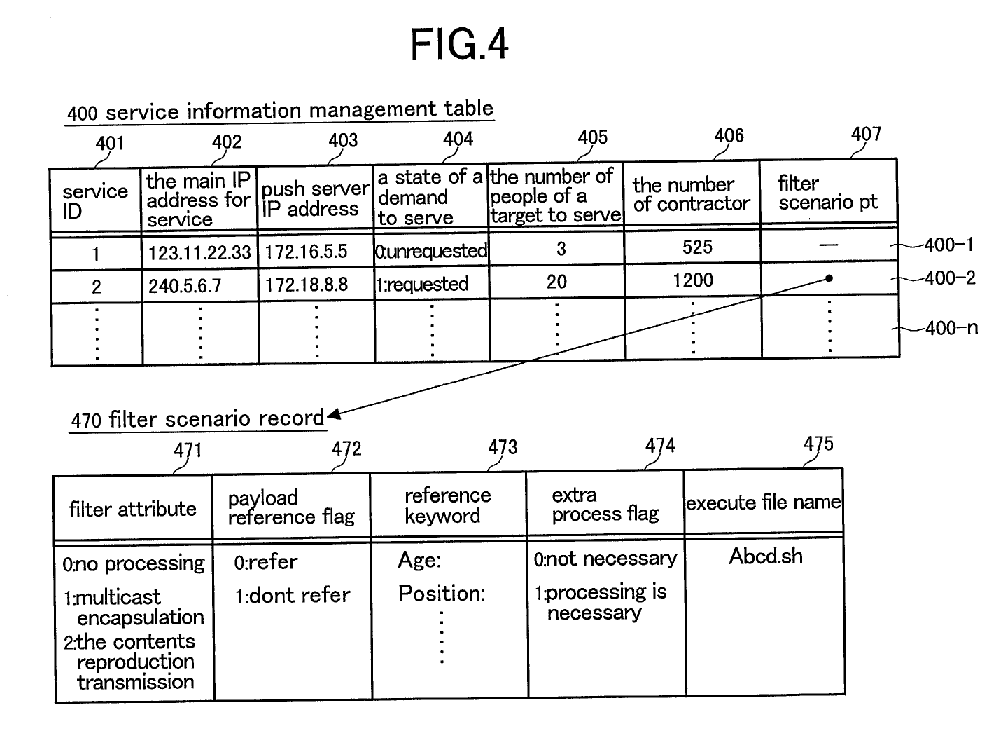

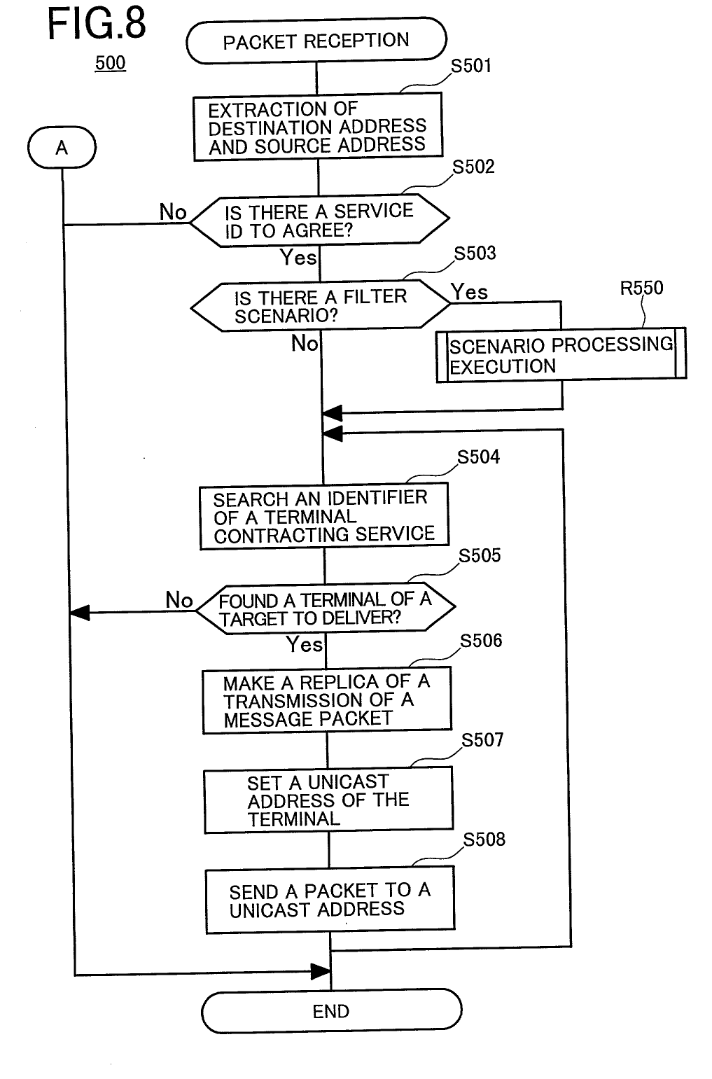

The memory 32 stores a program for transmitting and receiving signals to and from apparatuses on another IP network or apparatuses on the core network 14, a destination terminal information management table 300 as shown in FIG. 3 for storing various information regarding terminals in connection, which is obtained from the paging area server 7 and the contractor management node 4, and a service information management table 400 as shown in FIG. 4 for storing various information corresponding to services provided by the push server 1. As will be described hereinlater with reference to FIG. 8, these tables are referred to in order to specify the destination terminal of a packet received from the push server 1.

The destination terminal information management table 300 is used to specify mobile terminals as the destination of the contents information when a condition item for limiting receiving terminals is included in the contents information transmitted from the push server 1 to an indefinite number of mobile terminals. The destination terminal information management table 300 is comprised of, as shown in FIG. 3, a plurality of records 300-i (i=1 to n) corresponding to terminal IDs 301 assigned to the mobile terminals. Each record 300-i includes, as basic items 310 for specifying destination terminals, the terminal ID 301, an IP address 302 of a mobile terminal, an IP address 303 of a specific gateway preliminarily associated with the mobile terminal, and a contract service ID 304 for identifying service contracted by the mobile terminal. When the gateway 3 has the NAT function or when the push server 1 exists in the same network, the IP addresses 302 and 303 may be private addresses.

The record 300-i also includes, as additional items 320 depending on the kind of service provided to the mobile terminal, a pointer 305 to a contractor information record 350 indicative of information of the user of the mobile terminal, a pointer 306 to a terminal attribute record 360 indicative of attribute information of the mobile terminal, and a pointer 307 to a location information record 370 indicative of information of the present location (geographical location) of the mobile terminal.

The contractor information record 350 includes personal information of a contractor, such as name 351, address 352, age 353, sex 354, occupation 355, and the date 356 of contract. As the personal information, other items may be added. The terminal attribute record 360 includes attribute information of the mobile terminal such as manufacturer 361 of the terminal, model number (shape name) 362, and serial number 363, and other items may be added. The location information record 370 includes geographical location information such as latitude 371, longitude 372, and altitude 373 indicative of the present location of the mobile terminal. As location information, for example, the ID numbers of the cell 11 and the zone 9 in which the mobile terminal is located may be added.

Each of the records in the destination terminal information management table 300 is automatically generated, for example, when the power of the mobile terminal is turned on and the location of the mobile terminal is registered in the mobile packet communication network 12, in other words, at the time point when the mobile terminal is connected to the radio core network 14. In the invention, as will be described hereinlater, when the mobile terminal is connected to the radio core network, a request of setting the destination terminal information is automatically issued from the contractor management node 4 to the gateway 3. The gateway 3 generates a new table record of the table 300 on the basis of terminal management information included in the setting request and additional information obtained by inquiring the contractor management node 4 and the paging area server 7 as necessary.

As shown in FIG. 4, the service information management table 400 is comprised of a plurality of records 400-i (i=1 to n) corresponding to the kinds of services provided by the push server 1. Each record is constructed by: a service ID 401 corresponding to the contract service ID 304 used in the destination terminal information management table 300, a main IP address 402 for service to be used as an IP address when contents information is transmitted from the push server 1 to the gateway 3, an IP address 403 of the push server 1 for providing the service, a state 404 of a demand to serve indicating whether or not service is being demanded (contents distribution has been issued) to the push server 1, the number 405 of people of a target to serve, indicating the number of users (mobile terminals) to which the contents are delivered, the number 406 of contractors indicating the number of users contracting the service, and pointer information 407 to a filter scenario record 470 indicative of the contents of a process peculiar to the service to be executed when a packet including contents information is received.

The main IP address 402 is a global address to be used as a destination address of a service information packet corresponding to the service ID 401 and may be any of an IP address for unicast and an IP address for multicast. The IP address 403 of the push server 1 is used as a destination address in the case of transmitting a delivery start request or end request from the gateway 3 instead of the user to the push server 1 for providing services contracted by the terminal user. In the embodiment, when a packet is received from the push server, the IP address 403 is also used to specify the kind of service corresponding to the received packet. When the value of the number 407 of contractors becomes zero, that is, no user of the service exists, the record is deleted from the table 400.

The filter scenario record 470 includes a filter attribute 471 to be used to determine a delivering method with respect to specific service, a payload reference flag 472 indicating whether or not information indicative of the service delivering condition should be extracted from a payload of a received packet, a keyword 473 required in the case of extracting the delivery condition, an extra processing flag 474 indicating whether an extra processing is necessary or not in the case of, for example, collecting detailed terminal information from a server or the like connected to the outside of the gateway 3, and an execute file name 475 indicative of the file name to be referred to in the extra processing.

The gateway 3 specifies the kind of service corresponding to the packet received from the server 1 and, after that, performs a process for specifying mobile terminals to which the information is delivered or a contents converting process for converting the delivery information in accordance with the filter scenario record 470 pointed by the filter scenario pointer 407.

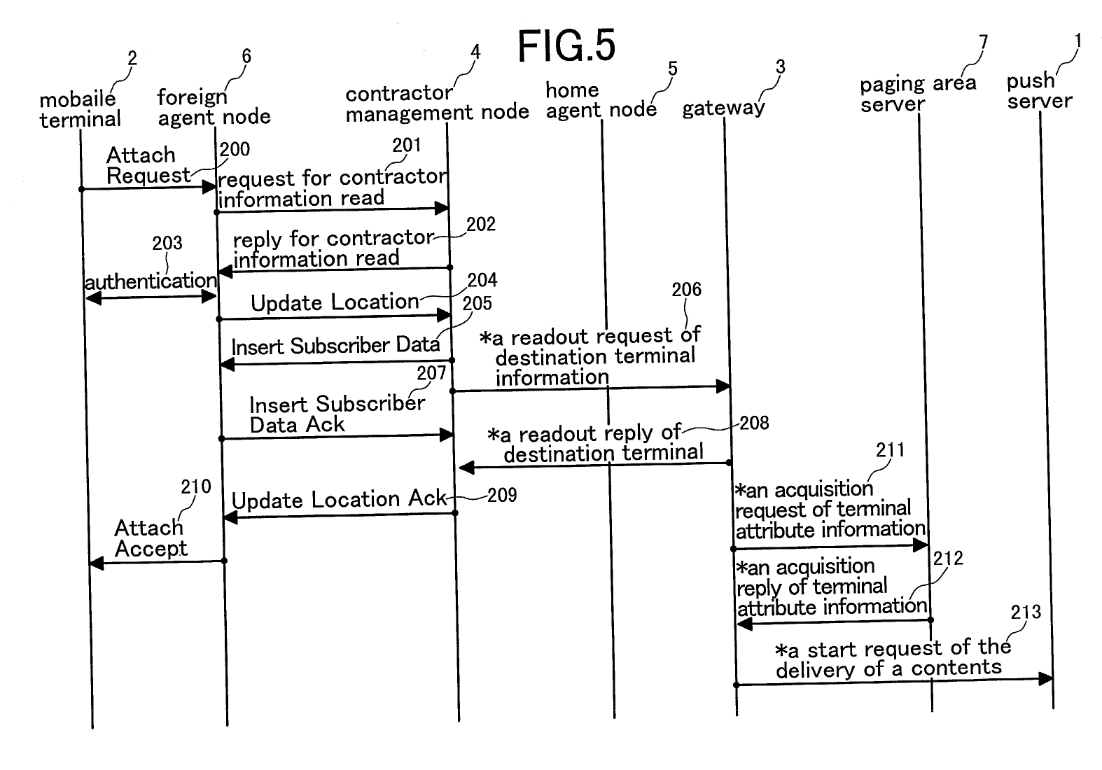

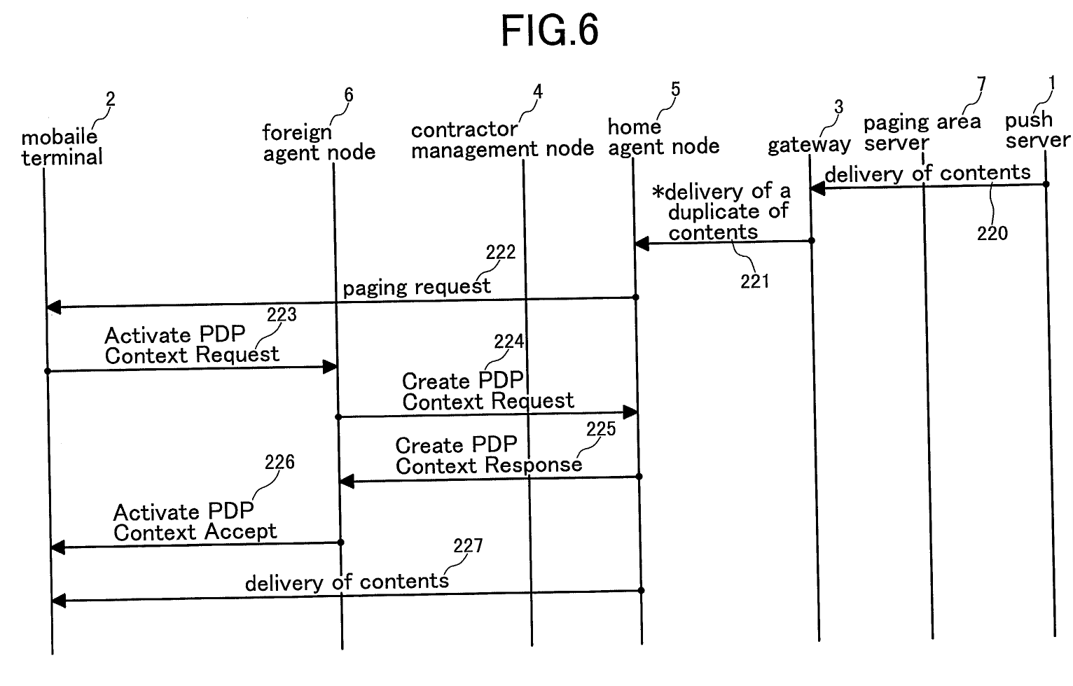

Referring to signal sequence charts shown in FIGS. 5 and 6, the procedure of the push-type information delivery service in the communication network illustrated in FIG. 1 will now be described. In the embodiment, it is assumed that a GPRS-base control signal is used as a control signal in a mobile packet communication network.

FIG. 5 shows a procedure at a preparation stage for the mobile terminal 2 to receive the push-type information delivery service from the server 1.

First, the mobile terminal 2 (for example, the terminal 2a in FIG. 1) sends an attach request signal 200 including a terminal ID to the foreign agent node 6a to register its visit location into the mobile packet communication network 12. On the basis of the terminal ID extracted from the signal 200, the foreign agent node 6a specifies the contractor management node 4 which holds the contractor information of the mobile terminal user, and transmits a request signal 201 for contractor information read to the contractor management node 4.

The contractor management node 4 reads out authentication information of the corresponding mobile terminal on the basis of the terminal ID included in the request signal 201 received, and transmits a reply signal 202 for contractor information read including the authentication information to the foreign agent node 6a.

The foreign agent node 6a executes authentication 203 on the mobile terminal 2a by using the authentication information included in the reply signal 202. When the authentication is finished normally, the foreign agent node 6a sends an update location signal 204 including both the identification of the mobile terminal 2a and the IP address of the foreign agent node 6a itself to the contractor management node 4. Upon receiving the signal 204, the contractor management node 4 stores the IP address of the foreign agent node 6a as visit location information corresponding to the ID of the terminal 2a, and transmits an insert subscriber data signal 205 including contract information corresponding to the terminal ID to the foreign agent node 6a.

The foreign agent node 6a stores the received information of the signal 205 and sends an insert subscriber data acknowledge signal 207 to the contractor management node 4. In response to the signal 207, the contractor management node 4 sends an update location acknowledge signal 209 indicative of the end of location information registration to the foreign agent node 6a. Upon receiving the signal 209, the foreign agent node 6a sends an attach accept signal 210 to the mobile terminal 2a. By the sequence, the contract or management node 4 recognizes that the mobile terminal 2a is connected to the mobile packet communication network 12.

According to the invention, the following sequence is executed to provide push-type information delivery service to the mobile terminal 2a connected to the mobile packet communication network 12.

In the push-type information delivery, it is necessary to register the mobile terminal 2a as a target, to which service information is delivered, at the time point when the mobile terminal 2a is connected to the network. In the invention, therefore, the contractor management node 4 recognizing that the mobile terminal 2a is connected to the network 2a sends a readout request 206 of destination terminal information to the gateway 3a so that the mobile terminal 2a is registered as a destination terminal. The request signal 206 includes such information that is shown in FIG. 3 as the basic items 310 in the destination terminal information management table 300.

The gateway 3a having received the signal 206 generates a new record to be registered into the destination terminal information management table 300 which includes the terminal ID 301, IP addresses 302 and 303, and contract service ID 304, and after that, transmits a readout replay signal 208 of destination terminal information to the contractor management node 4. The gateway 3a sends an acquisition request 211 of terminal attribute information including the terminal ID of the mobile terminal 2a as key information to the paging area server 7 in order to supplement the destination terminal information received from the contractor management node 4. When servers for managing the terminal attribute information other than the paging area server 7 exist, the acquisition request 221 of terminal attribute information is transmitted to each server, too.

When an acquisition reply 212 of terminal attribute information is received from the paging area server 7 and other terminal attribute information server, the gateway 3a registers a new record with attribute information extracted from the received signal to the destination terminal information management table 300. The information of the contractor information record 350 and the terminal attribute record 360 shown in FIG. 3 may be notified by the readout request signal 206 of destination terminal information sent from the contractor management node 4 to the gateway 3a, or may be notified from the contractor management node 4 to the gateway 3a in response to the acquisition request 211 of terminal attribute information from the gateway 3a.

In the invention, the gateway 3a checks to see whether or not every request has been issued to the applicable push server to provide contents delivery service with respect to services contracted by the mobile terminal 2a for which the destination terminal information has been set. If there is service for which a request has not been issued yet, the gateway 3a sends a start request 213 of the delivery of contents to the applicable push server, instead of the mobile terminal 2a.

The above check to see whether the delivery service has already been requested or not is made by referring to the service information management table 400 shown in FIG. 4 on the basis of the contract service ID 304 registered in the destination terminal information management table 300, and checking the state 404 of a demand to serve in a table record corresponding to the contract service ID 304. When the state 404 of a demand to serve shows a state where a demand of delivery has not been issued to the push server, the start request 213 of the delivery of the contents is sent by using the push server IP address 403 in the table record as a destination and using the IP address of the gateway 3a as a request source (sender). After that, the state 404 of the demand to serve is changed to the demanded state.

FIG. 6 is a processing sequence performed in the case where the push server 1a delivers a service information (contents) packet to the gateway 3a as a service request source. As an example, the case where the push server 1a delivers the contents 202 as information delivery service to a limited area will be described here.

The push server 1a delivers the contents 220 in response to the start request 213 of the delivery of the contents to the IP address of the gateway 3a as a request source. The gateway 3a having received the contents specifies a mobile terminal to which the received contents is to be transferred with reference to the destination terminal information management table 300 shown in FIG. 3 and the service information management table 400 shown in FIG. 4.

For example, when the contents 220 is to be received by mobile terminals positioned in the specific area surrounded by the thick line 15 in FIG. 1, the gateway 3a searches the destination terminal information management table 300 for a record in which the service ID of the received contents 220 is registered as the contract service ID 304, and accesses the location information record 370 in accordance with the pointer 407, thereby determining whether the current location of the applicable mobile terminal is within the designated area or not. By repeating the determination, the IP addresses 302 of mobile terminals to be the destinations of the contents 220, for example, the terminals 2a and 2b are specified. The gateway 3a delivers duplicates 221 of the received contents to the mobile terminals in a unicasting manner. Specifically, a duplicate of the contents is sent in accordance with the order of retrieving the mobile terminals by referring to the tables, first, to the IP address of the mobile terminal 2a and, then, to the IP address of the mobile terminal 2b, and so on.

When a communication path to the mobile terminal 2a is already established, the home agent node 5a can send the duplicate 221 of the contents from the gateway 3a to the mobile terminal 2a via the foreign agent node 6a in the zone in which the mobile terminal 2a as a destination is located at present (227). If the communication path to the mobile terminal 2a as a destination has not been established, the home agent node 5a sends the paging request signal 222 to the mobile terminal 2a in order to establish a communication path with a foreign agent node in the zone in which the mobile terminal 2a is located. In this case, in response to reception of the signal 222, the mobile terminal 2a sends an active PDP context request signal 223 including the terminal ID to the foreign node 6a in the visit location. Then, the foreign node 6a sends a create PDP context request signal 224 to the home agent node 5a corresponding to the mobile terminal 2a. The home agent node 5a stores the IP address of the foreign node included in the signal 224 and, after that, transmits a create PDP context response signal 225 to the foreign node 6a. The foreign node 6a having received the response signal 225 transmits an active PDP context accept signal 226 to the mobile terminal 2a, thereby establishing a communication path between the mobile terminal 2a and the home agent node 5a. Delivery of contents (227) is carried out through the communication path from the home agent node 5a to the mobile terminal 2a.

By the above procedure, the push-type information delivery service can be realized from the push server 1a to an indefinite number of mobile terminals located in the specific area 15 in the radio access network 13. Also in the case where the push server delivers contents information by designating attributes such as the model number of the mobile terminal and date of contract other than the location in place of designating the area, the gateway 3 can specify the mobile terminal to which the contents are to be delivered in a manner similar to the above.

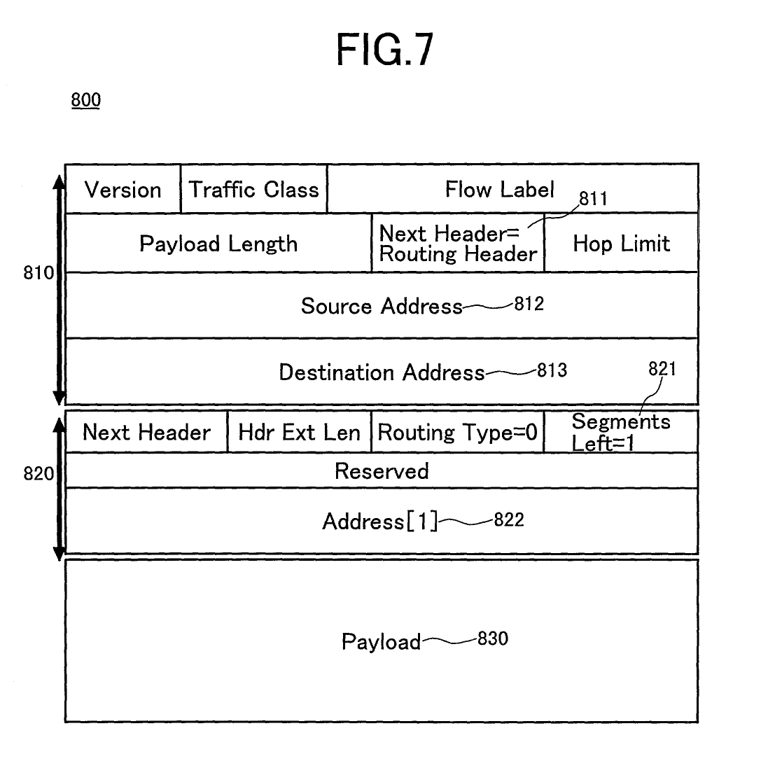

FIG. 7 shows the format of an IP packet 800 communicated between the mobile terminal 2 and the push server 1. Although an IPv6 packet or IPv4 packet may be used as the IP packet, the case of using an IPv6 packet capable of inserting an expanded header after the IPv6 header will be described here.

The IP packet 800 is comprised of an IPv6 header 810, an IPv6 expanded header 820, and a payload 830. In the embodiment, the format of a packet using a routing header as the IPv6 expanded header 820 is shown in consideration of a fact that the IP packet is transmitted from the push server 1 to a specific gateway 3. The IPv6 header 810 includes version number, traffic class, flow label, payload length, next header type 811, hop limit, source address 812, and destination address 813.

The next header type 811 is used to identify the next area of the IPv6 header 810. When ordinary high-order protocol data is loaded in the payload 830, the protocol number of the high order protocol is set in the next header type 811. In the case of inserting the-IPv6 expanded header 820 after the IPv6 header, the value indicative of the kind of the IPv6 expanded header is set in the next header type 811. In the invention, the next header type 811 is used in the case of analyzing an encapsulated multicast packet or encapsulating a unicast packet.

In the destination address 813, usually, the IPv6 address of an apparatus is set as a final destination. According to the embodiment, in the destination address 813 of the IP packet transmitted from the push server 1, the global address or multicast address of the gateway 3 is set. The gateway 3 changes the destination address 813 of the IP packet received from the push server 1 to the unicast address of each of mobile terminals to be the destination of contents information. In the case where a plurality of nodes exist between the push server 1 and the gateway 3 and the routing header 820 is added to the IP packet, not the final destination but the address of a node via which the packet is relayed is set as the destination address 813.

The routing header 820 is constructed by next header type, header length, routing type, the number 821 of remaining segments, and address 822. The number 821 of remaining segments includes the number of intermediate nodes through which the packet has not passed yet, and the address 822 includes the address of an intermediate node through which the packet should be relayed. In the address 822, addresses of a plurality of intermediate nodes may be set.

The push server 1 sets condition information of a destination and a keyword together with service information (contents information) in the payload 830 of an IP packet, and transmits the IP packet to the gateway 3. The gateway 3 determines whether referring to the payload is necessary or not in accordance with a preset filter scenario record and reads out the destination condition information and keyword from the payload 830 as necessary.

FIG. 8 is a flowchart of a packet receiving process program 500 executed by the gateway 3 (3a, 3b) to specify the destination mobile terminal of the packet received from the push server 1.

The program 500 is started each time the gateway 3 (3a, 3b) receives an IP packet from the IP core network (backbone) 8. When the received packet is an encapsulated one, the program 500 is started after the received packet is decapsulated. For example, when the push server 1b shown in FIG. 1 delivers contents in the multicast packet format, in a network such as the Internet which does not guarantee forwarding of the multicast packet, it is desired that the gateway 3c located at the entrance of the network encapsulates the multicast packet received from the push server 1b and converts it to a unicast packet. In this case, each of the gateways 3a and 3b decapsulates the received packet from the gateway 3c and, after that, executes the program 500.

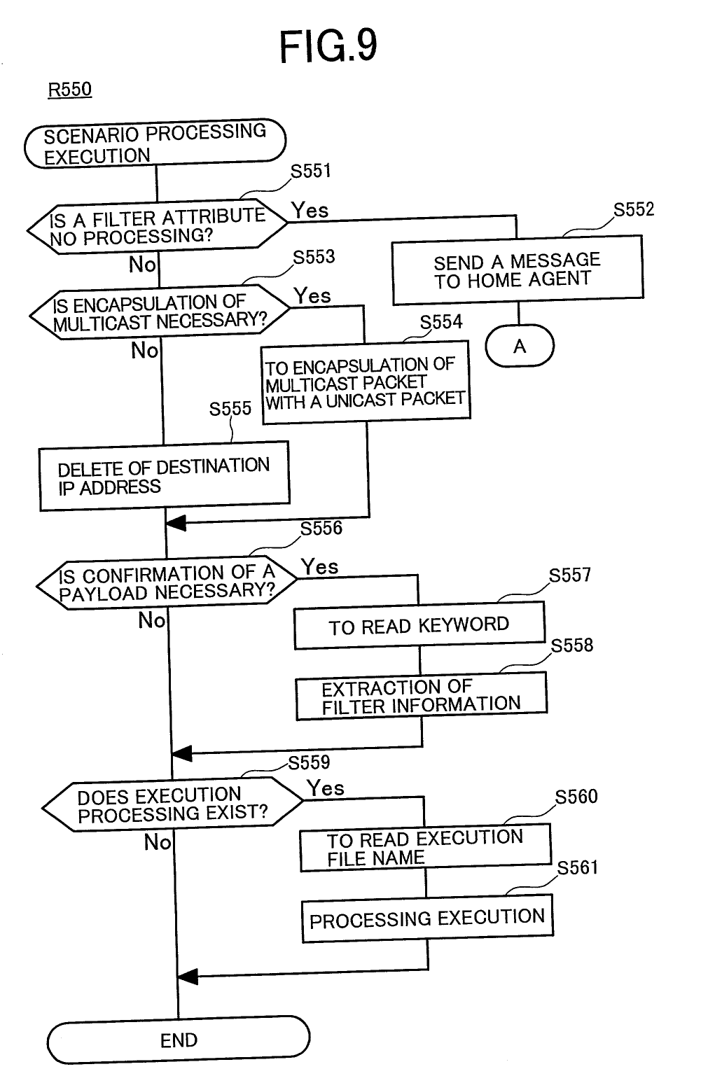

In the program 500, the destination address and the source address are extracted from the received packet (S501). The destination address and the source address are compared with the main IP address 402 for service and the push server IP address 403 in the service information management table 400 to determine whether there is a matching record or not, that is, the presence or absence of the service ID 401 corresponding to the received packet (S502). When no service ID matching the received packet exists in the service information management table 400, the received packet is sent out to the home agent node 5 connected to the gateway 3, and the execution of the program is terminated. When a service ID matching the received packet exists, whether filter information is defined or not is checked from the filter scenario pointer 407 of the corresponding record (S503). If the filter information is defined, the filter scenario record 470 designated by the pointer 407 is read out and a scenario processing R550 shown in FIG. 9 is executed.

In the scenario processing R550, first, a filter attribute 471 of the filter scenario record 470 is referred to (S551). When the filter attribute 471 indicates “no processing”, the received packet is sent to the home agent node 5 connected to the gateway 3 without performing a special process on the received packet (S552), and the execution of the packet receiving process program 500 is terminated. When the received packet is a multicast packet and the scenario attribute 471 instructs encapsulation of the received multicast packet, the received multicast packet is encapsulated and converted to a unicast packet (S554). Since the address value of the encapsulated unicast packet is set after a destination specifying process which will be described hereinafter, a dummy value is set at this time point. If the scenario attribute does not instruct encapsulation of the multicast packet, the multicast address of the received packet is deleted to send a duplicate of the contents, and a dummy unicast address is set (S555).

Subsequently, by referring to the payload reference flag 472 in the filter scenario record 470, whether confirmation of the payload to specify the destination terminal is necessary or not is determined (S556). When confirmation of the payload is necessary, a designated keyword is read out from the reference keyword 473 in the filter scenario record 470 (S557) and filter information is extracted from the payload of the received packet to store in a work area (S558) After that, the special processing flag 474 in the filter scenario record 470 is referred to and whether a processing peculiar to service to be executed exists or not is determined (S559). If there is a processing to be executed, the execute file name is extracted from an execute file name 475 in the filter scenario record 470 (S560) and the processing indicated by the execute file name (S561) is carried out. After that, the scenario process is terminated. As the processing executed in the step 561, a process of obtaining terminal information which is not held by the gateway 3 from other server and a process of adding an expanded header and additional information to a received packet are exemplified.

Referring again to FIG. 8, when the scenario processing R550 is finished or there is no scenario processing to be executed, the destination terminal information management table 300 is referred to by using the service ID 401 discriminated in step S502 as a retrieval key, and a record having a service ID matching the key as a contract service ID 304 is retrieved. By this operation, the terminal ID 301 contracting the delivery service of contents information given by the received packet of this time is retrieved (S504) At this time, if filter information is stored in the work area in the scenario processing R550, the filtering of the destination terminal is performed according to the contents of the contractor information record 350, terminal attribute record 360, or location information record 370 corresponding to the filter information.

When a mobile terminal to be a destination of the received packet is found by the searching of the management table 300 and the filtering (S505), a duplicate of the received packet or the packet encapsulated in the scenario processing R550 is produced (S506), the IP address 303 of the mobile terminal is set as the destination IP address (unicast address) of the duplicate packet (S507), and the duplicate packet is sent out to the unicast address (S508). After that, the program sequence returns to the step S504 to repeat retrieval of a mobile terminal as a next destination. When the retrieval is completed on all of the records registered in the destination terminal information management table 300, that is, there is no more mobile terminal to be a target of delivery (S505) the execution of the program is terminated.

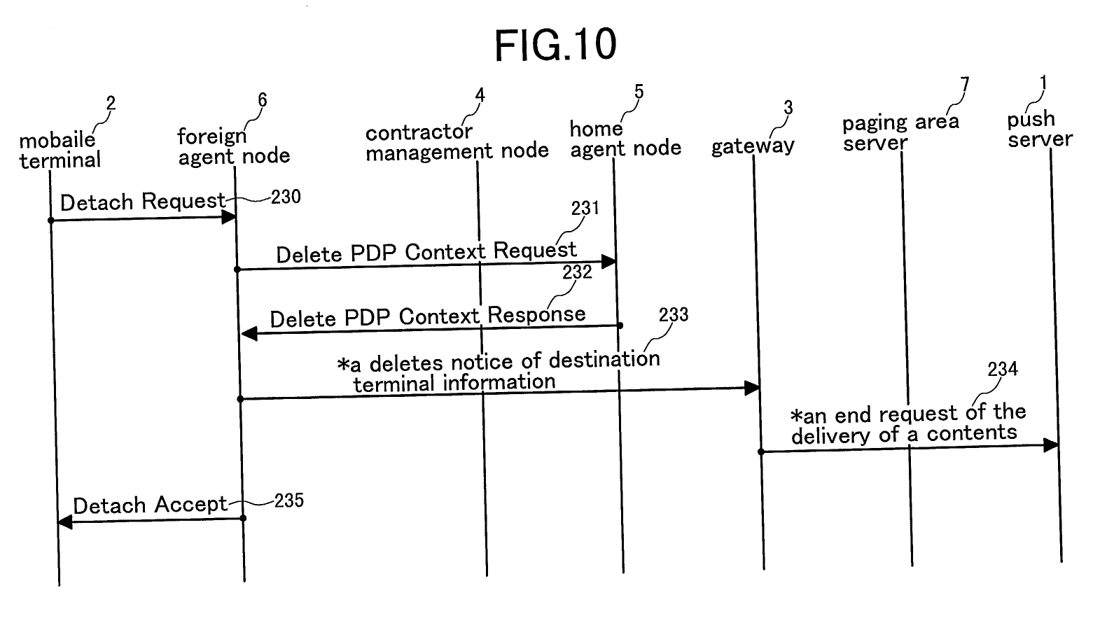

FIGS. 10 to 12 show a procedure necessary to terminate the information delivery service to the mobile terminal 2. The information delivery service to a mobile terminal is terminated in response to the disconnection between the mobile terminal and the communication network. The connection between the mobile terminal and the communication network is disconnected by, for example, (1) a disconnection request from the mobile terminal, (2) a disconnection request from the foreign agent node 6, and (3) a disconnection request from the contractor management node 4.

FIG. 10 shows a procedure of ending the information delivery service in the case (1).

For example, when the power source of the mobile terminal 2a is switched off, a detach request signal 230 including the terminal ID is transmitted from the mobile terminal 2a to the foreign agent node 6a. Upon receiving the request signal, the foreign agent node 6a sends a delete PDP context request signal 231 to the home agent node 5a corresponding to the mobile terminal 2a. The home agent node 5a having received the request signal 231 deletes the communication path information of the mobile terminal 2a, and sends a delete PDP context response signal 232 to the foreign agent node 6a. Upon receiving the response signal 232, the foreign agent node 6a sends a detach accept signal 235 to the mobile terminal 2a.

By the above sequence, the procedure of disconnecting the mobile terminal 2a and the network is terminated. In order to terminate the information delivery service from the gateway 3 to the mobile terminal 2a, according to the invention, the foreign agent node 6a has the function of sending a delete notice signal 233 of destination terminal information including the ID of the mobile terminal 2a to the gateway 3a when the response signal 232 is received from the home agent node 5a.

The gateway 3a having received the signal 233 reads out the contract service ID 304 of the mobile terminal 2a from the table record having the ID of the mobile terminal 2a in the destination terminal information management table 300, and subtracts the value of the number 405 of people of a target to serve by one in the table record corresponding to the contract service ID 304 on the service information management table 400. If it is found from the result of the subtraction that the value of the number 405 of people of a target to serve became zero, an end request 234 of the delivery of contents is sent to the push server indicated by the push server IP address 403 in the table record. After that, the state 404 of a demand to serve in the table record is changed to a state indicative of no demand. Since the information delivery service becomes unnecessary for the mobile terminal 2a, the table record for the mobile terminal 2a is deleted from the destination terminal information management table 300.

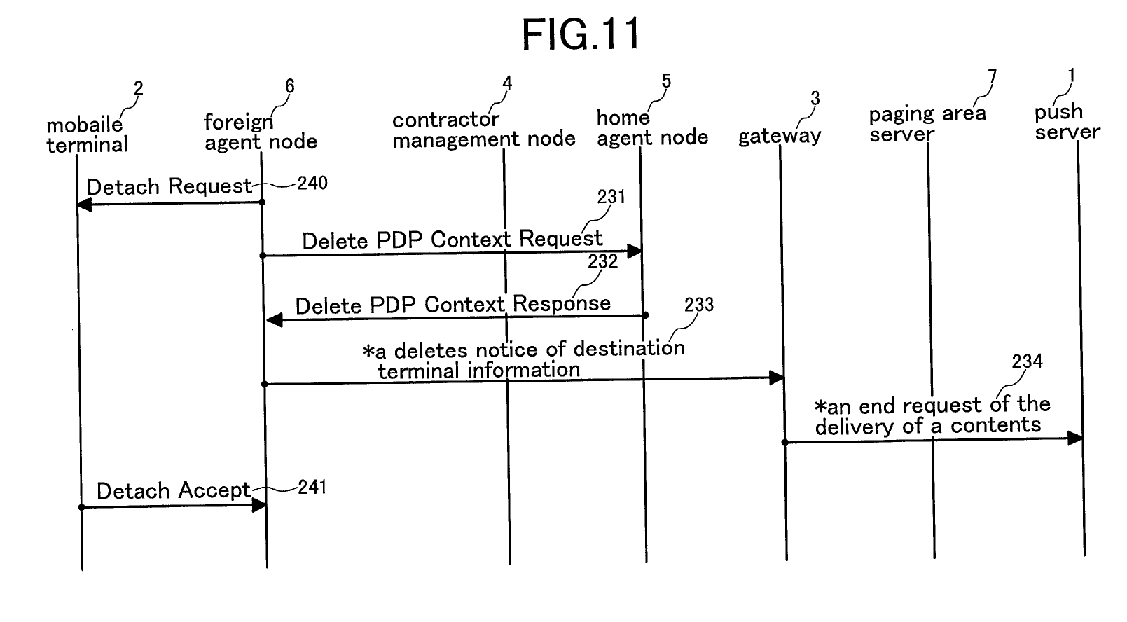

FIG. 11 shows a procedure of ending the information delivery service in the case (2).

A disconnection request from the foreign agent node 6 to the mobile terminal 2 in connection is issued, for example, when the core network 14 is congested. As compared with FIG. 10, in the case (2), only the relation between the source and destination of the detach request signal 240 and the detach accept signal 241 is opposite to that in the case (1). The transmission of the delete notice 233 of destination terminal information from the foreign agent node 6 and the responding operation of the gateway 3 are similar to those in the case (1).

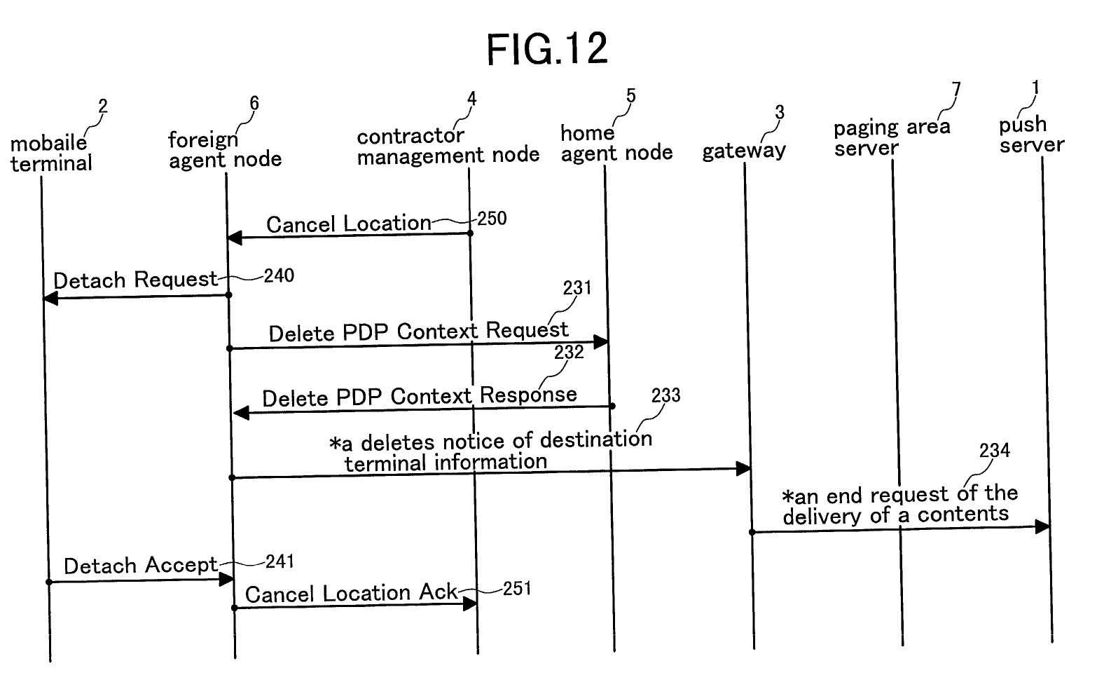

FIG. 12 shows a procedure of ending the information delivery service in the case (3).

In the case (3), for example, the contractor management node 4 issues a forced disconnection request to the mobile terminal 2a when it is detected that the mobile terminal 2a has not used the network for long time. When a cancel location signal 250 is received from the contract or management node 4, the foreign agent node 6 sends the detach request signal 240 to the corresponding mobile terminal. Upon receiving the detach accept signal from the mobile terminal, the foreign agent node 6 sends a cancel location acknowledge signal 251 to the contractor management node 4. The operation of the foreign agent node 6 and the operation of the gateway 3 after transmission of the detach request signal 240 are similar to those in the case (2).

As obviously understood from the description of the embodiments, according to the invention, associating with location registration of the mobile terminal, the request of setting management information for providing the information service to the mobile terminal is issued from the management node to the gateway, and the service start request is automatically issued from the gateway to the applicable server as necessary. Accordingly, it is possible to provide the push-type information service to a mobile terminal without requiring a function change to the mobile terminal. In the invention, the service information packet from the server is received the gateway interposed between the mobile terminal and the server, and a duplicate of the received packet is transmitted as a unicast packet to the destination terminal specified by the gateway. It is therefore unnecessary for the server side to manage the mobile terminals as destinations.

According to the invention, for example, even in the case where the server sends service information with delivery conditions for specifying target users, such as the current location or area of the user, user's age group, and the model of the mobile terminal, the gateway automatically selects a group of mobile terminals matching the delivery conditions to deliver a received packet to them. By changing the address of a transmission packet and received packet by the gateway, information service can be provided also to a mobile terminal having a private IP address by a server on the Internet.

What is claimed is:

1. An information providing method on a communication network including a mobile packet communication network accommodating a plurality of mobile terminals via a radio channel and an IP (Internet Protocol) core network to which a server for providing information service is connected, said mobile packet communication network and the IP core network being connected via a gateway apparatus, the method comprising the steps of:
making a request from a service management node for managing visit location information of each mobile terminal in said mobile packet communication network to said gateway apparatus to set management information for providing information service to a mobile terminal, in an execution process of a procedure for accommodating the mobile terminal to said mobile packet communication network; and
registering management information regarding said mobile terminal into a management table by said gateway apparatus in response to reception of said setting request, checking whether a service request has been issued to a service provider with respect to information service indicated by a service identifier included as a part of said management information and, making a request by said gateway apparatus to a specific server in said IP core network as said service provider to start the information service if a service request has not been issued.

2. An information providing method according to claim 1, wherein said service management node requests setting of said management information designating at least an address of said mobile terminal and an identifier of information service to be provided, and
said gateway apparatus registers said management information including the information designated by said setting request and attribute information regarding said mobile terminal obtained from other server, into said management table.

3. An information providing method according to claim 1, wherein when a packet including service information is received from said specific server, said gateway apparatus refers to said management table and transfers said received packet to said mobile packet communication network by using the address of said mobile terminal registered as a part of the management information as a destination.

4. An information providing method according to claim 1, wherein said gateway apparatus has: a first management table for storing, in correspondence with each service identifier, an address of a server operating as a provider of service, a destination address to be attached to a service information packet, and status information indicative of whether a service request has been issued or not; and a second management table for storing management information regarding said mobile terminal is registered, and
when a packet including the service information is received from said specific server, said gateway apparatus specifies a service identifier corresponding to said received packet with reference to said first management table, searches said second management table for a management information record including said service identifier to thereby specify an address of a mobile terminal to which said received packet is to be transferred, and transfers said received packet or a duplicate of said received packet to said address.

5. An information providing method according to claim 4, wherein a filtering condition is designated in correspondence with a specific service identifier in said first management table, and
when a packet including service information is received from said specific server, in the case where a filtering condition is designated in correspondence with a service identifier specified in said first management table, said gateway apparatus uses an address of a mobile terminal of which management information satisfies said filtering condition among addresses of mobile terminals specified in said second management table as a destination of said received packet.

6. An information providing method according to claim 4, wherein said second management table permits registration of a plurality of service identifiers with respect to a single mobile terminal.

7. An information providing method according to claim 3, wherein said gateway apparatus converts a destination address of a packet received from said specific server from a global IP address to a local IP address, and transfers the resultant to said mobile packet communication network.

8. An information providing method on a communication network including a mobile packet communication network accommodating a plurality of mobile terminals via a radio channel and an IP (Internet Protocol) core network to which a server for providing information service is connected, said mobile packet communication network and the IP core network being connected via a gateway apparatus, the method comprising the steps of:
making a request from a service management node for managing a visit location of each mobile terminal in said mobile packet communication network to said gateway apparatus to set management information for providing information service to a mobile terminal by designating a mobile terminal address and an information service identifier at the time of registering location of the mobile terminal in said mobile packet communication network; and
registering the management information regarding said mobile terminal into a management table by said gateway apparatus having received said setting request, checking whether a service request has been issued to a service provider with respect to information service to be provided to said mobile terminal and, making a request to a specific server as said service provider to start the information service when a service request has not been made.

9. An information providing method according to claim 8, wherein when said gateway apparatus registers the management information regarding a mobile terminal into a management table, location information obtained from a location information server for managing geographical local information of each mobile terminal in said mobile packet communication network is registered as a part of the management information into said management table, and
when a packet designating a delivery area as information service is received from said specific server, said gateway apparatus refers to said management table to select an address of a terminal to which said received packet is to be delivered among a group of mobile terminals of which present location is in said designated area, and transfers said received packet to said mobile packet communication network by using said address as a destination address.

10. A gateway apparatus for connecting a mobile packet communication network accommodating a plurality of mobile terminals via a radio channel, and an IP (Internet Protocol) core network to which a server for providing information service is connected, comprising:
means for registering management information regarding said mobile terminal into a management table when a setting request of the management information for information service to said mobile terminal is received from a service management node for managing a visit location of the mobile terminal in said mobile packet communication network, and if a service request of information service for said mobile terminal has not been made to a service provider, requesting a specific server as said service provider to start the information service; and
packet transferring means for specifying when a packet including service information is received from said specific server, an address of a mobile terminal, to which information service by said received packet is to be provided, based on said management table and transferring said received packet to said mobile packet communication network by using the address as a destination address.

11. A gateway apparatus according to claim 10, wherein said packet transferring means includes means for receiving a packet including said service information in a multicast packet format from said specific server and transferring the packet in a unicast packet format to a mobile terminal specified by said management table.

12. A gateway apparatus according to claim 10, wherein said packet transferring means includes means for converting a destination address of a packet received from said specific server from a global IP address to a private IP address, and transferring the resultant packet to said mobile packet communication network.

13. A gateway apparatus according to claim 10, further comprising:
a first management table for storing, in correspondence with a service identifier, an address of a server as a provider of service, a destination address to be attached to a service information packet, and status information indicative of whether a service request has been issued or not; and
a second management table for storing management information regarding said mobile terminal, and
wherein when a packet including the service information is received from said specific server, said received packet transferring means specifies a service identifier corresponding to said received packet with reference to said first management table, searches said second management table for a management information record including said service identifier to thereby specify an address of a mobile terminal to which said received packet is to be transferred, and transfers said received packet or a duplicate of said received packet to said mobile terminal address.
